(19) United States
(12) Patent Application Publication
(10) Pub. No.: US 2013/0117599 A1
(43) Pub. Date: May 9, 2013

(54) SEMICONDUCTOR DEVICE OPERATING ACCORDING TO LATENCY VALUE

(71) Applicant: Elpida Memory, Inc., Tokyo (JP)

(72) Inventors: Yoko MOCHIDA, Tokyo (JP); Hiroshi NAKAGAWA, Tokyo (JP)

(73) Assignee: ELPIDA MEMORY, INC., Tokyo (JP)

(21) Appl. No.: 13/671,400

(22) Filed: Nov. 7, 2012

(30) Foreign Application Priority Data
Nov. 7, 2011 (JP) 2011-243120

(51) Int. Cl. G06F 1/04

(52) U.S. Cl. 713/503

(57) ABSTRACT

Disclosed herein is a device that includes a first register temporarily storing first information indicative of a reference latency, a second register temporarily storing second information indicative of an offset latency, a third register temporarily storing third information indicative of one of first and second operation modes, and a logic circuit configured to produce latency information in response to the first information when the third information is indicative of the first operation mode and to both of the first information and the second information when the third information is indicative of the second operation mode.

### BACKGROUND OF THE INVENTION

1. Field of the Invention

The present invention relates to a semiconductor device, and more particularly to a semiconductor device that controls input and output timing of read data and write data according to a latency value.

2. Description of Related Art

A synchronous memory device, represented by a synchronous DRAM (Dynamic Random Access Memory), has been widely used for a main memory of a personal computer and the like. The synchronous memory device inputs or outputs data in synchronism with an external clock signal supplied from a controller. Therefore, the use of a higher-speed clock signal leads to an increase in data transfer rate.

However, even in the synchronous DRAM, a DRAM core still operates in an analog mode, requiring a sense operation to amplify extremely weak electric charges. As a result, it is not possible to reduce the time required to output the first data after a read command is issued. Therefore, after a predetermined delay time has passed since the issuing of the read command, the first data are output in synchronism with an external clock signal (See Japanese Patent Application Laid-open No. 2010-3397).

The delay time in the read operation is usually referred to as “CAS latency,” and is set to the integral multiple of a clock cycle. For example, when the CAS latency is five (CL=5), the first data are output in synchronism with an external clock signal of five cycles after a read command is received in synchronism with an external clock signal. That is, five clock cycles later, the first data are output.

Such a delay is necessary even for a write operation. In the write operation, after a predetermined delay time has passed since the issuing of a write command, data need to be input sequentially in synchronism with the external clock signal. The delay time in the write operation is usually referred to as “CAS write latency,” and is set to the integral multiple of a clock cycle. For example, when the CAS write latency is five (CWL=5), the first data need to be input in synchronism with the external clock signal of five clock cycles after the write command is issued in synchronism with the external clock signal.

### SUMMARY

In one embodiment, there is provided a device that includes: a first register temporarily storing first information indicative of a reference latency; a second register temporarily storing second information indicative of an offset latency; a third register temporarily storing third information indicative of one of first and second operation modes; and a logic circuit configured to produce latency information in response to the first information when the third information is indicative of the first operation mode and to both of the first information and the second information when the third information is indicative of the second operation mode.

In another embodiment, there is provided a device that includes: a first register storing a value of a reference latency in a binary form; a second register storing a value of an offset latency in a binary form; a third register in which an operation mode is set; a first logic circuit configured to subtract the value of the offset latency from the value of the reference latency to generate a first control signal indicative of a value of an adjustment latency in a binary form; a second logic circuit configured to decode the first control signal to generate a second control signal indicative of the value of the adjustment latency in a decoded form; and a latency counter configured to perform a count operation in synchronism with a first internal clock signal according to the second control signal when a first operation mode is set in the third register, and perform a count operation in synchronism with a second internal clock signal according to the value of the reference latency when a second operation mode is set in the third register.

In still another embodiment, there is provided a device that includes: a first register storing a value of a reference latency; a second register storing a value of an offset latency; a first logic circuit configured to logically synthesize the values of the reference latency and the offset latency to generate a first control signal; and a second logic circuit configured to decode the first control signal to generate a second control signal.

### BRIEF DESCRIPTION OF THE DRAWINGS

FIG. 1 is a schematic diagram for explaining one embodiment of the present invention;

FIG. 2 is a block diagram indicating a semiconductor device according to an embodiment of the present invention;

FIG. 3 is a schematic diagram showing some of registers included in a mode register shown in FIG. 2;

FIG. 4 is a timing chart for explaining a method for updating set values of the mode register through a data input/output terminal shown in FIG. 2;

FIG. 5 is a block diagram of the logic circuits included in the mode register;

FIG. 6 is a table for explaining the values of the CAS latency (CL) and the offset latency (SRL);

FIG. 7 is a circuit diagram of a logic circuit 100 shown in FIG. 5;

FIG. 8 is a circuit diagram of a logic circuit 200 shown in FIG. 5;

FIG. 9 is a truth table that lists all the combinations of the possible values of the CAS latency (CL) and those of the offset latency (SRL);

FIG. 10 is a block diagram of a prototype logic circuit that the inventors have conceived in the course of making the present invention;

FIG. 11 is a circuit diagram of a decoder 300 shown in FIG. 10;

FIG. 12 is a circuit diagram of a decoder 400 shown in FIG. 10;

FIG. 13 is a circuit diagram of a logic circuit 500 shown in FIG. 10; and

FIG. 14 is a timing chart for explaining the operation of the semiconductor device according to the embodiment of the present invention.

### DETAILED DESCRIPTION OF THE EMBODIMENTS

An embodiment of the present invention will be described in detail below. However, the present invention is not limited thereto, and it will be understood by those skilled in the art that appropriate modifications may be made according to the claims of the present application.

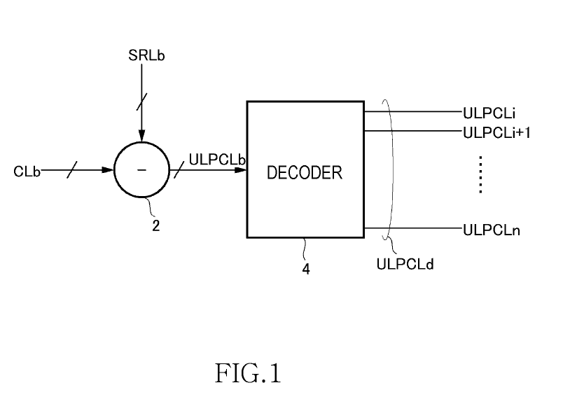

Referring now to FIG. 1, a logic circuit of one embodiment of the present invention includes a subtractor 2 and a decoder 4. A signal CLb of binary form indicating the value of a reference latency (CL) and a signal SRLb of binary form indicating the value of an offset latency (SRL) are supplied to the subtractor 2. The symbols with a trailing “b” represent that those signals are of binary form.

The subtractor 2 performs an operation “CL-SRL” and outputs the resulting signal ULPCLb. The signal ULPCLb is a signal of binary form indicating the value of an adjustment latency (ULPCL). The decoder 4 receives and decodes the signal ULPCLb of binary form to generate a signal ULPCLd of decoded form. The symbol with a trailing “d” represents that the signal is of decoded form. The signal ULPCLd of decoded form includes signals ULPCLi to ULPCLn, one of which becomes an active level.

As described above, in the present embodiment, a reference latency such as a CAS latency and a CAS write latency is offset. If an internal clock signal that is phase-controlled is not available, the input and output timing of data needs to be controlled in synchronism with an internal clock signal that is not phase-controlled. The foregoing offset can compensate a possible delay, for example, in the output timing of read data in a read operation due to a circuit delay. More specifically, the offset is used to generate an adjustment latency having a value smaller than that of the reference latency by one or more, and the output timing of read data can be determined based on the adjustment latency. In the present embodiment, the value of the reference latency (CL) and that of the offset latency (SRL) are operated in a binary form, and the resulting signal ULPCLb of binary form is decoded. This can reduce the entire circuit scale as compared to when the values of the reference latency (CL) and the offset latency (SRL) are decoded before operation.

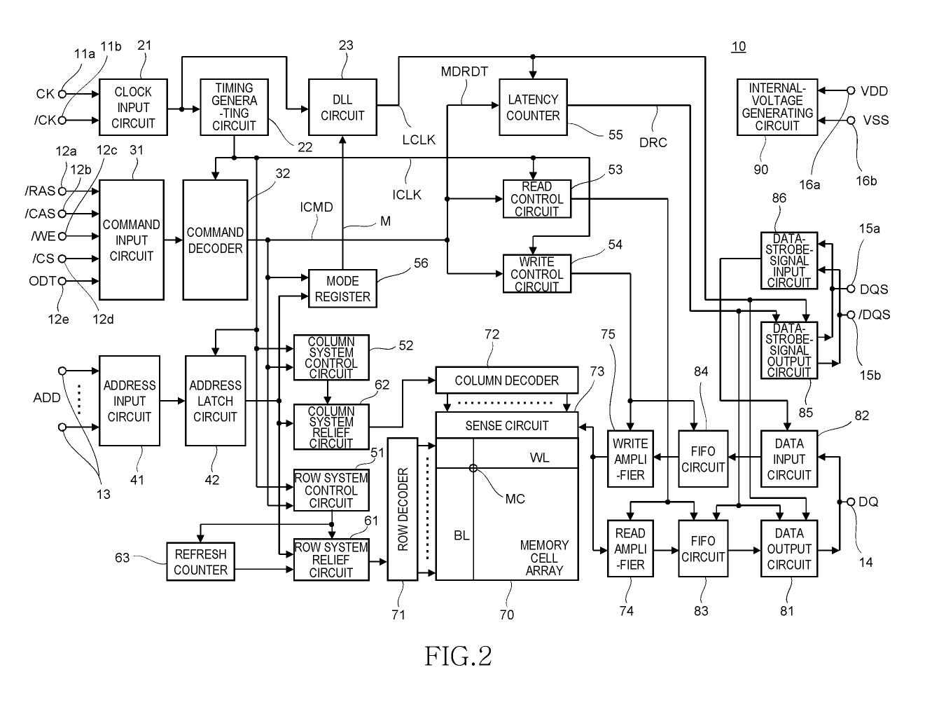

Turning to FIG. 2, a semiconductor device 10 of the present embodiment is a synchronous DRAM integrated in a single silicon chip. The semiconductor device 10 is provided with a plurality of external terminals that include clock terminals 11a and 11b, command terminals 12a to 12e, address terminals 13, a data input/output terminal 14, data strobe terminals 15a and 15b, and power-supply terminals 16a and 16b. Besides the above terminals, a calibration terminal, clock enable terminal and the like are included, but are not shown in the diagram.

The clock terminals 11a and 11b are supplied with external clock signals CK and /CK, respectively. The external clock signals CK and /CK are transferred to a clock input circuit 21. In the present specification, a signal whose name starts with “/” is an inverted signal of the corresponding signal or low active signal. Accordingly, the external clock signals CK and /CK are complementary to each other. An output signal of the clock input circuit 21 is supplied to a timing generating circuit 22 and a DLL circuit 23. The timing generating circuit 22 generates an internal clock signal ICLK and supplies it to various internal circuits except circuits of a data output system. The DLL circuit 23 generates an internal clock signal LCLK and supplies it to the circuits of the data output system. The internal clock ICLK may be referred to as a “first internal clock signal,” and the internal clock signal LCLK as a “second internal clock signal.”

The internal clock signal ICLK generated by the timing generation circuit 22 is not phase-controlled with respect to the external clock signals CK and /CK. On the other hand, the internal clock signal LCLK generated by the DLL circuit is phase-controlled with respect to the external clock signals CK and /CK. The internal clock signal LCLK is somewhat advanced in phase with respect to the external clock signals CK and /CK so that the phase of read data DQ (and data strobe signals DQS and /DQS) coincides with that of the external clock signals CK and /CK.

Whether or not to use the DLL circuit 23 is selected according to an operation mode set in the mode register 56. More specifically, if a “DLL on mode” is selected in the mode register 56, the DLL circuit 23 is activated to generate the internal clock signal LCLK that is phase-controlled. On the other hand, if a “DLL off mode” is selected in the mode register 56, the DLL circuit 23 is deactivated to quit generating the internal clock signal LCLK. The DLL off mode is an operation mode to be selected when a low power consumption operation is needed. In this specification, the DLL off mode may be referred to as a “first operation mode.” The DLL on mode may be referred to as a “second operation mode.” The timing generation circuit 22 is activated regardless of which is selected, the DLL on mode or the DLL off mode. The reason is that the internal clock signal ICLK is needed in both modes.

When the DLL off mode is selected, the circuits constituting the data output-system use the internal clock signal ICLK instead of the internal clock signal LCLK. Unlike the internal clock signal LCLK, the internal clock signal ICLK is not advanced in phase with respect to the external clock signals CK and /CK. When the DLL off mode is selected, the output timing of read data therefore lags somewhat behind as compared to when the DLL on mode is selected.

The command terminals 12a to 12e are supplied with a row address strobe signal /RAS, a column address strobe signal /CAS, a write enable signal /WE, a chip select signal /CS, and an on die termination signal ODT, respectively. The above command signals are transferred to a command decoder 32 via a command input circuit 31. The command decoder 32 generates various internal commands ICMD by performing a process of holding and decoding command signals and other processes in synchronism with the internal clock signal ICLK. The internal commands ICMD are supplied to a row system control circuit 51, a column system control circuit 52, a read control circuit 53, a write control circuit 54, a latency counter 55, and the mode register 56. The internal commands ICMD includes a read command MDRDT that is supplied to the latency counter 55.

The latency counter 55 is a circuit that delays the read command MDRDT such that the read data is output after the CAS latency (CL) has passed since the issuing of the read command MDRDT. Such an operation is performed in synchronism with the internal clock signal LCLK if the DLL on mode is selected, and in synchronism with the internal clock signal ICLK if the DLL off mode is selected. The value of the CAS latency (CL) is specified by a set value of the mode register 56.

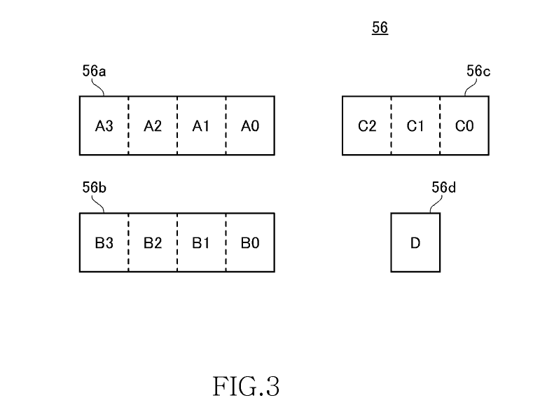

As shown in FIG. 3, the mode register 56 includes at least registers 56a to 56d. The register 56a is provided for storing the value of a CAL latency (CL), and has a four-bit configuration including unit registers A0 to A3. In this specification, the register 56a may be referred to as a “first register.” The values set in the unit registers A0 to A3 may be referred to as “a first plurality of bits.” The register 56b is provided for storing the value of a CAS write latency (CWL), and has a four-bit configuration including unit registers B0 to B3. The register 56c is provided for storing the value of an offset latency (SRL), and has a three-bit configuration including unit registers C0 to C2. In this specification, the register 56c may be referred to as a “second register.” The values set in the unit registers C0 to C2 may be referred to as “a second plurality of bits.” The register 56d is provided for selecting either one of the DLL on mode and the DLL off mode, and has a one-bit configuration including a unit register D. In this specification, the register 56d may be referred to as a “third register.”

The CAS latency (CL) refers to the number of clock cycles that indicates the period from the issuance of a read command to the output of read data DQ. The CAS write latency (CWL) refers to the number of clock cycles that indicates the period from the issuance of a write command to the input of write data DQ. The offset latency (SRL) is a value to be used when the DLL off mode is selected. The offset latency (SRL) indicates the number of clock cycles to be subtracted from the CAS latency (CL) and the CAS write latency (CWL) set in the register 56a and 56b, respectively. When the DLL off mode is selected, the period from the issuance of a read command to the output of read data DQ is defined by CL-SRL, and the period from the issuance of a write command to the input of write data DQ is defined by CWL-SRL.

When the DLL on mode is selected, the period from the issuance of a read command to the output of read data DQ is defined by the value of the CAS latency (CL) itself, and the period from the issuance of a write command to the input of write data DQ is define by the value of the CAS write latency (CWL) itself. It should be noted that if there is set an additive latency (AL), the read command or write command is issued one or more clock cycles before the original issuance timing.

Although not limited in particular, the set values of the registers 56a, 56b, and 56d in the mode register 56 are supplied from outside through the address terminals 13. The set value of the register 56c is supplied from outside through the data input/output terminal 14. The set values of the registers 56 may be updated through the address terminals 13 by using a known method. More specifically, a mode register set command is issued through the command terminals 12a to 12d, and a set value to be set into the mode register 56 is input to the address terminals 13.

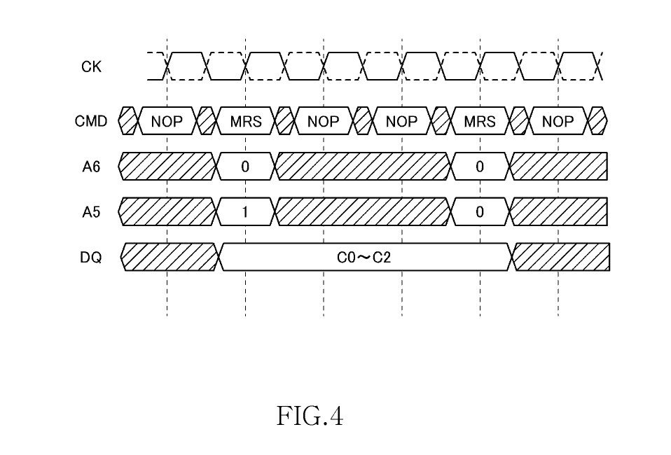

A method for updating set values of the mode register 56 through the data input/output terminal 14 is explained with reference to FIG. 4.

In the example shown in FIG. 4, a mode register set command MRS is issued and predetermined bits A5 and A6 of the mode register 56 are set to logic levels of “1” and “0,” respectively, through the address terminals 13. The mode register 56 thereby enters an offset latency program mode, where set values of the mode register 56 can be updated through the data input/output terminal 14. In such a state, the value of the offset latency (SRL) is input from outside through the data input/output terminal 14, and the input value is written to the three bits of unit registers C2 to C0 constituting the register 56c. For example, the offset latency (SRL) may be input in parallel by using three data input/output terminals. Then, the mode register set command MRS is issued again and the predetermined bits A5 and A6 of the mode register 56 are set to logic levels of “0” and “0,” respectively, through the address terminals 13. The mode register 56 thereby exits from the offset latency program mode. The set value of the register 56c can be updated by such a procedure.

The values set in the registers are logically operated by logic circuits included in the mode register 56. A specific circuit configuration of the logic circuits included in the mode register 56 will be described later.

Turning back to FIG. 2, the address terminals 13 are supplied with an address signal ADD. The address signal ADD is transferred to an address latch circuit 42 through an address input circuit 41. The address latch circuit 42 latches the address signal ADD in synchronism with the internal clock signal ICLK. If the address signal ADD latched in the address latch circuit 42 is a row address, the address signal ADD is supplied to a row system relief circuit 61. If the address signal ADD latched in the address latch circuit 42 is a column address, the address signal ADD is supplied to a column system relief circuit 62. The row system relief circuit 61 is also supplied with another row address generated by a refresh counter 63. The address signal ADD is supplied to the mode register 56 when entering a mode register set mode.

When a row address indicating a defective word line is supplied, the row system relief circuit 61 relieves the row address by accessing a redundant word line instead of the original word line. An operation of the row system relief circuit 61 is controlled by the row system control circuit 51, and an output of the row system relief circuit 61 is supplied to a row decoder 71. The row decoder 71 selects any one or ones of word lines WL included in a memory cell array 70. As shown in FIG. 2, in the memory cell array 70, a plurality of word lines WL and a plurality of bit lines BL cross each other, and memory cells MC are disposed at points of intersection between the word lines WL and the bit lines BL, respectively. FIG. 2 shows only one of the word lines WL, one of the bit lines BL, and a memory cell MC arranged at the intersection. The bit lines BL are connected to respective sense amplifiers SA included in the sense circuit 73.

When a column address indicating a defective bit line is supplied, the column system relief circuit 62 relieves the column address by accessing a redundant bit line instead of the original bit line. An operation of the column system relief circuit 62 is controlled by the column system control circuit 52, and the output signal therefrom is supplied to a column decoder 72. The column decoder 72 selects any one or ones of sense amplifiers SA included in the sense circuit 73.

The sense amplifier SA selected by the column decoder 72 is connected to a read amplifier 74 at the time of a read operation and connected to a write amplifier 75 at the time of a write operation. The operation of the read amplifier 74 is controlled by the read control circuit 53, and the operation of the write amplifier 75 is controlled by the write control circuit 54.

The data input/output terminal 14 outputs read data DQ and inputs write data DQ, and is connected to a data output circuit 81 and a data input circuit 82. In this specification, the data output circuit 81 and the data input circuit 82 may be referred to collectively as a “data input/output circuit.” The data output circuit 81 is connected to the read amplifier 74 via a FIFO circuit 83, and thereby, a plurality of prefetched read data DQ are burst-outputted from the data input/output terminal 14. The data input circuit 82 is connected to the write amplifier 75 via a FIFO circuit 84, and thereby, a plurality of write data DQ burst-inputted from the data input/output terminal 14 is simultaneously written in the memory cell array 70. While FIG. 2 shows only one data input/output terminal 14, a plurality of data input/output terminals 14 may be provided.

The data strobe terminals 15a and 15b input and output the data strobe signals DQS and /DQS, and are connected to a data-strobe-signal output circuit 85 and a data-strobe-signal input circuit 86, respectively.

As shown in FIG. 2, the data output circuit 81 and the data-strobe-signal output circuit 85 are supplied with the internal clock signal LCLK generated by the DLL circuit 23 and an output control signal DRC generated by the latency counter 55. The output control signal DRC is also supplied to the FIFO circuit 83. Note that when the DLL off mode is selected, the internal lock signal ICLK is used instead since the internal clock signal LCLK is not available.

The power supply terminals 16a and 16b are supplied with power supply potentials VDD and VSS, respectively, and connected to an internal-voltage generating circuit 90. The internal-voltage generating circuit 90 generates various types of internal voltages.

The overall configuration of the semiconductor device 10 according to the present embodiment has been described so far. Next, a specific circuit configuration of the logic circuits included in the mode register 56 will be described.

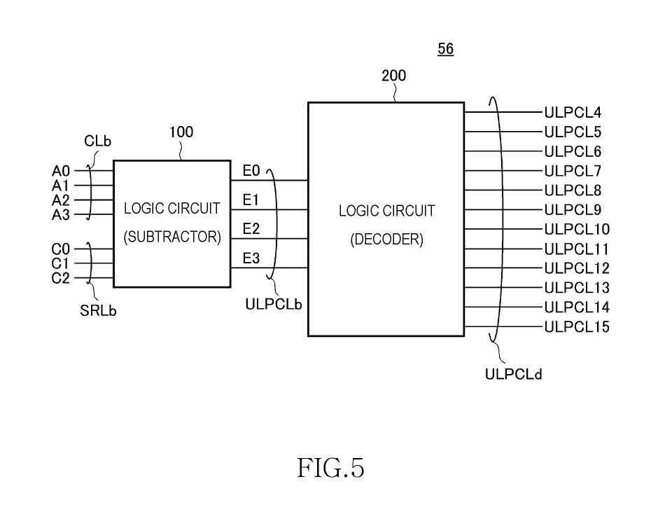

Turning to FIG. 5, the mode register 56 includes two logic circuits 100 and 200. A signal CLb indicates the value of the CAS latency (CL) in a binary form and a signal SRLb indicates the value of the offset latency (SRL) in a binary form. These signals CLb and SRLb are supplied to the logic circuit 100. The signal CLb is a four-bit signal including bits A0 to A3, output from the register 56a. The signal SRLb is a three-bit signal including bits C0 to C2, output from the register 56c. The logic circuit 100 performs subtraction processing on the values in a binary form to generate a signal ULPCLb of binary form. The signal ULPCLb of binary form is a four-bit signal including bits E0 to E3. In this specification, the logic circuit 100 may be referred to as a “first logic circuit.” The bits E0 to E3 constituting the signal ULPCLb may be referred to as a “first plurality of control signals.”

The logic circuit 200 receives and decodes the signal ULPCLb of binary form to generate a signal ULPCLd of decoded form. The signal ULPCLd of decoded form is a 12-bit signal including bits ULPCL4 to ULPCL15, only one of which becomes an active level. The active-level bit indicates the value of the adjustment latency (ULPCL) that is offset. For example, if the bit ULPCL10 is activated, it represents that the value of adjustment latency (ULPCL) is “10.” The value of the adjustment latency (ULPCL) is thus selected within the range of “4” and “15.” In this specification, the logic circuit 200 may be referred to as a “second logic circuit.” The bits ULPCL4 to ULPCL15 constituting the signal ULPCLd may be referred to as a “second plurality of control signals.”

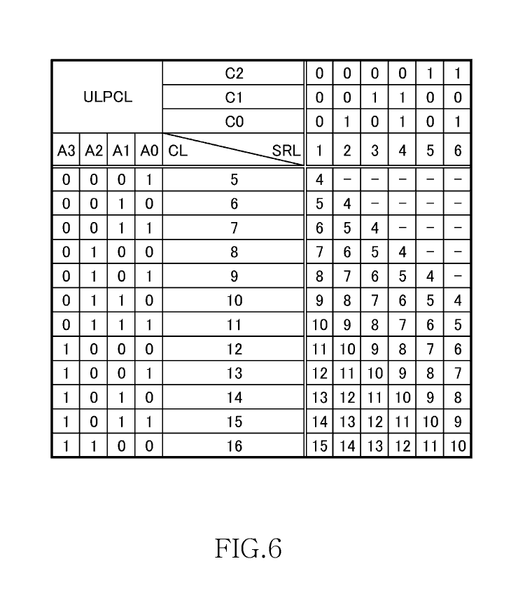

Turning to FIG. 6, the value of the CAS latency (CL) is expressed in a binary form with the bit A0 as the least significant bit and the bit A3 as the most significant bit. Note that if the bits A0 to A3 are “0001b” in value, it represents that the CAS latency (CL) has a value of “5.” If the bits A0 to A3 are “1100b” in value, it represents that the CAS latency (CL) has a value of “16.” In other words, different values are expressed than with an ordinary binary signal. Possible values of the bits A0 to A3 are “0001b=(5)” to “1100b=(16).” The other values are invalid.

The value of offset latency (SRL) is expressed in a binary form with the bit C0 as the least significant bit and the bit C2 as the most significant bit. If the bits C0 to C2 are “000b” in value, it represents that the offset latency (SRL) has a value of “1.” If the bits C0 to C2 are “101b” in value, it represents that the offset latency (SRL) have a value of “6.” That is, different values are expressed than with an ordinary binary signal. Possible values of the bits C0 to C2 are “000b=(1)” to “101b=(6).” The other values are invalid.

The final value of the adjustment latency (ULPCL) is determined by a combination of the values of the CAS latency (CL) and the offset latency (SRL). The value of the adjustment latency (ULPCL) is given by CL-SRL. FIG. 6 shows the specific combinations. The adjustment latency (ULPCL) has 12 possible values ranging from 4 to 15.

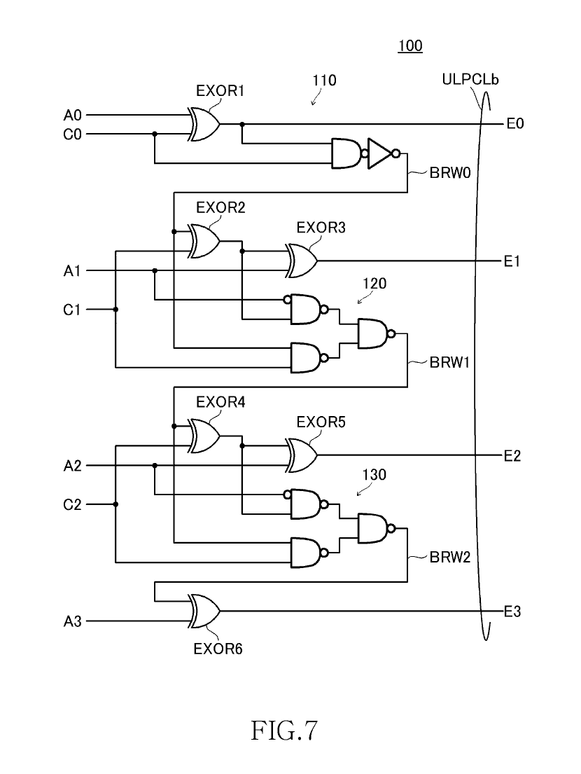

As shown in FIG. 7, the logic circuit 100 includes a subtractor 110 which logically synthesizes the bits A0 and C0 to generate the bit E0, a subtractor 120 which logically synthesizes the bits A1 and C1 to generate the bit E1, and a subtractor 130 which logically synthesizes the bits A2 and C2 to generate the bit E2.

The subtractor 110 includes an exclusive OR gate circuit EXOR1 which receives the bits A0 and C0. The output of the exclusive OR gate circuit EXOR1 is used as the bit E0. If the logic levels of the bits A0 and C0 coincide with each other, the logic level of the bit E0 becomes “0.” On the other hand, if the logic levels of the bits A0 and C0 do not coincide with each other, the logic level of the bit E0 becomes “1.” In particular, if the logic level of the bit A0 is “0” and the logic level of the bit C0 is “1,” the subtraction produces a negative and a borrow bit BRW0 becomes a high level. The borrow bit BRW0 is supplied to the subtractor 120 of higher order.

The subtractor 120 includes an exclusive OR gate circuit EXOR2 which receives the bit C1 and the borrow bit BRW0, and an exclusive OR gate circuit EXOR3 which receives the bit A1 and the output of the exclusive OR gate circuit EXOR2. The output of the exclusive OR gate circuit EXOR3 is used as the bit E1. When the borrow bit BRW0 is at a low level, the logic level of the bit E1 is “0” if the logic levels of the bits A1 and C1 coincide with each other, and the logic level of the bit E1 is “1” if the logic levels of the bits A1 and C1 do not coincide with each other. On the other hand, when the borrow bit BRW0 is at a high level, the bit C1 is inverted by the exclusive OR gate circuit EXOR2. The resulting value of the bit E1 is thus inverse to the foregoing. If the subtraction produces a negative, a borrow bit BRW1 becomes a high level. The borrow bit BRW1 is supplied to the subtractor 130 of yet higher order.

The subtractor 130 has basically the same circuit configuration as that of the subtractor 120. The subtractor 130 includes an exclusive OR gate circuit EXOR4 which receives the bit C2 and the borrow bit BRW1, and an exclusive OR gate circuit EXOR5 which receives the bit A2 and the output of the exclusive OR gate circuit EXOR4. The output of the exclusive OR gate circuit EXOR5 is used as the bit E2. When the borrow bit BRW1 is at a low level, the logic level of the bit E2 is “0” if the logic levels of the bits A2 and C2 coincide with each other, and the logic level of the bit E2 is “1” if the logic levels of the bits A2 and C2 do not coincide with each other. On the other hand, when the borrow bit BRW1 is at a high level, the bit C2 is inverted by the exclusive OR gate circuit EXOR4. The resulting value of the bit E2 is thus inverse to the foregoing. If the subtraction produces a negative, a borrow bit BRW2 becomes a high level.

The borrow bit BRW2 and the bit A3 are supplied to an exclusive OR gate circuit EXOR6. When the borrow bit BRW2 is at a low level, the logic level of the bit E3 coincides with that of the bit A3. When the borrow bit BRW2 is at a high level, the logic level of the bit E3 coincides with the inverted level of the bit A3.

With the foregoing configuration, the operation CL-SRL is performed in a binary form. The resulting signal ULPCLb is thus a signal of binary form. The signal ULPCLb of binary form is supplied to the logic circuit 200 in the subsequent stage.

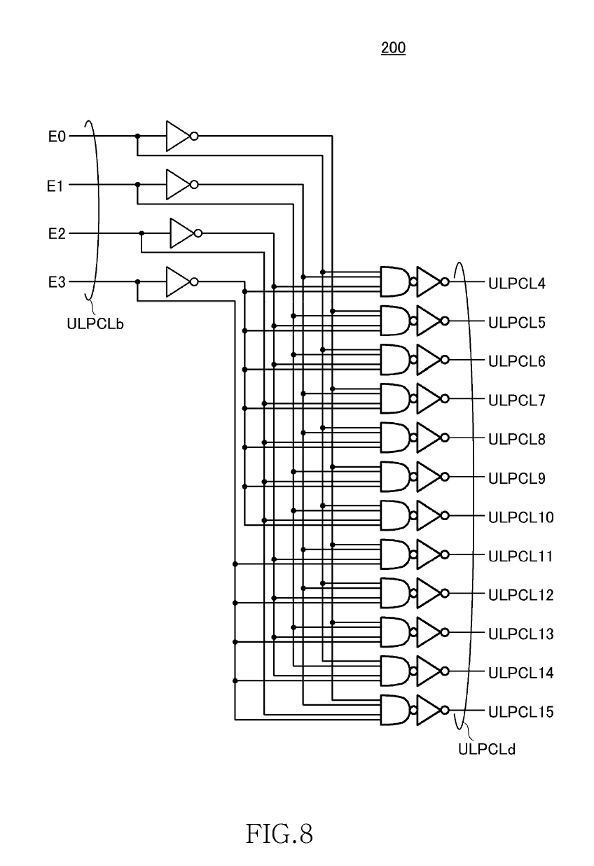

As shown in FIG. 8, the logic circuit 200 is a so-called decoding circuit, and functions to convert the signal ULPCLb of binary form into the signal ULPCLd of decoded form. The signal ULPCLb of binary form has a four-bit configuration and can thus express 16 numerical values at maximum. Since the adjustment latency (ULPCL) has 12 possible values as described above, circuit portions corresponding to the unused values of the signal ULPCLb are omitted. When the signal ULPCLb of binary form is supplied to the logic circuit 200, only one of the 12 bits of signals ULPCL4 to ULPCL15 constituting the signal ULPCLd of decoded form becomes an active level.

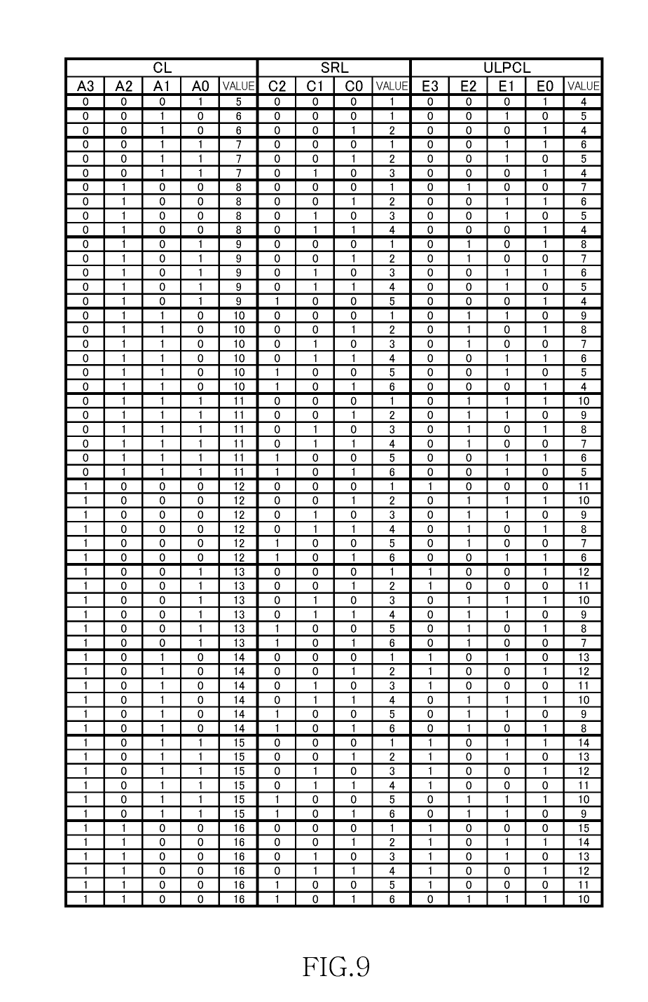

As shown in FIG. 9, the total number of combinations, or patterns, of the possible values of the CAS latency (CL) and those of the offset latency (SRL) is 57. In the present embodiment, the logic circuit 100 performs subtraction processing before the logic circuit 200 performs decoding. The signals ULPCL4 to ULPCL15 for specifying the adjustment latency (ULPCL) can thus be obtained with a relatively simple circuit configuration.

The resulting signals ULPCL4 to ULPCL15 are supplied to the latency counter 55 shown in FIG. 2. When the DLL off mode is selected, the latency counter 55 delays the read command MDRDT according to the activated bit among the signals ULPCL4 to ULPCL15, and outputs the resultant as an output control signal DRC. For example, if the signal ULPCL10 is activated, the latency counter 55 delays the read command MDRDT by 10 clock cycles in synchronism with the internal clock signal ICLK, and outputs the resultant as the output control signal DRC. Consequently, the data input/output terminal 14 starts to output read data DQ at timing according to the value of the adjustment latency (ULPCL).

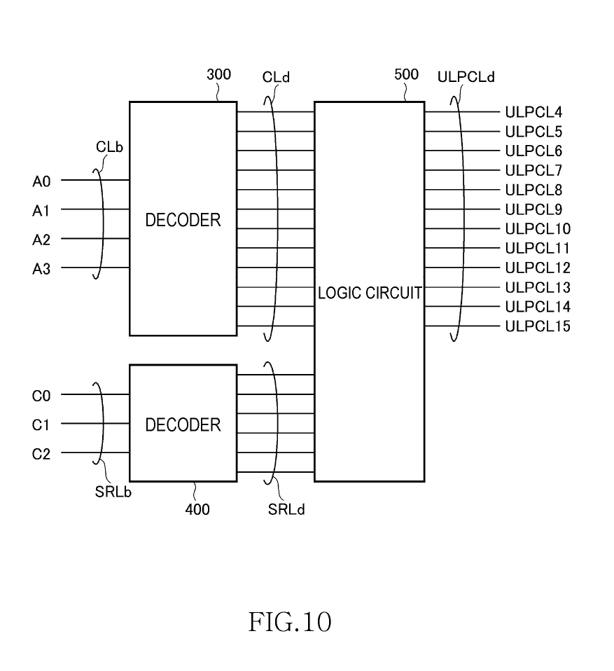

In the prototype example shown in FIG. 10 that the inventors have conceived in the course of making the present invention, the logic circuit includes a decoder 300 which decodes the signal CLb of binary form indicating the value of the CAS latency (CL), and a decoder 400 which decodes the signal SRLb of binary form indicating the value of the offset latency (SRL). Signals CLd and SRLd of decoded form output from the decoders 300 and 400 are supplied to a logic circuit 500 for subtraction processing.

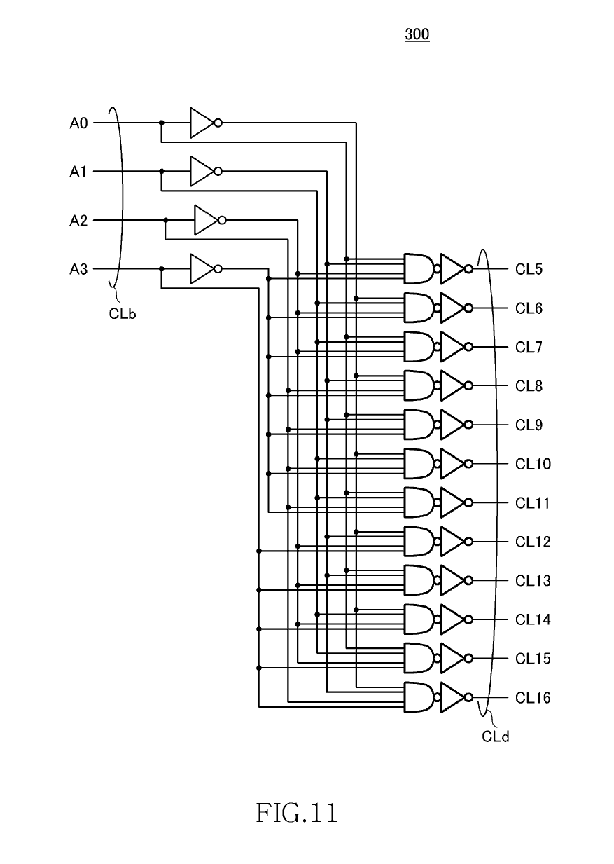

As shown in FIG. 11, the decoder 300 decodes the four-bit signal CLb including the bits A0 to A3, and activates any one of 12 bits of signals CL5 to CL16 constituting the signal CLd of decoded form. Since the CAS latency (CL) has 12 possible values as described above, circuit portions corresponding to the unused values of the signal CLb are omitted.

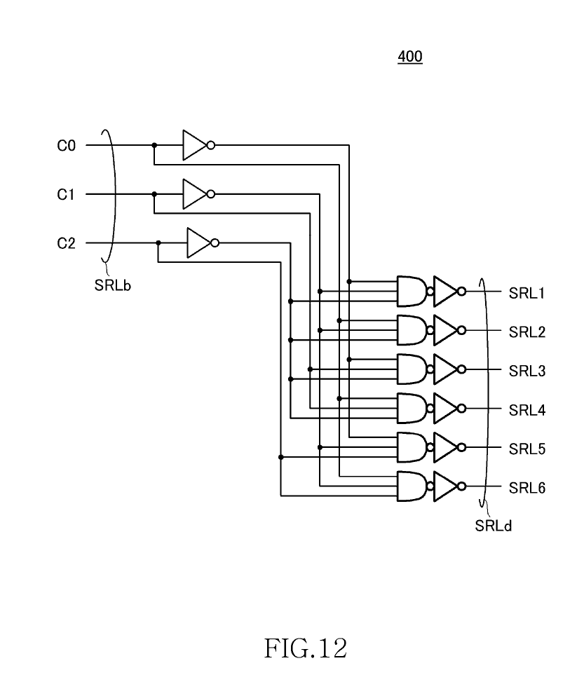

As shown in FIG. 12, the decoder 400 decodes the three-bit signal SRLb including the bits C0 to C2, and activates any one of six bits of signals SRL1 to SRL6 constituting the signal SRLd of decoded form. Since the offset latency (SRL) has six possible values as described above, circuit portions corresponding to the unused values of the signal SRLb are omitted.

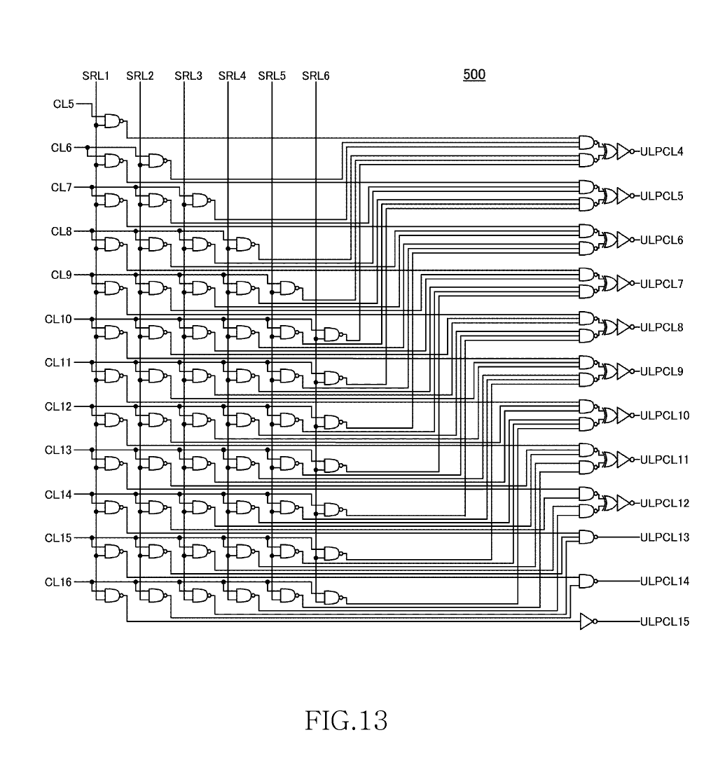

As shown in FIG. 13, the logic circuit 500 includes NAND gate circuits corresponding to all the combinations of the possible values of the CAS latency (CL) and those of the offset latency (SRL). The number of NAND gate circuits needed is thus 57. Since NAND gate circuits for summarizing the outputs of the 57 NAND gate circuits are also needed, the circuit scale becomes relatively large.

In contrast, according to the semiconductor device 10 of the present embodiment described above, the adjustment latency (ULPCL) can be obtained with a relatively simple circuit configuration.

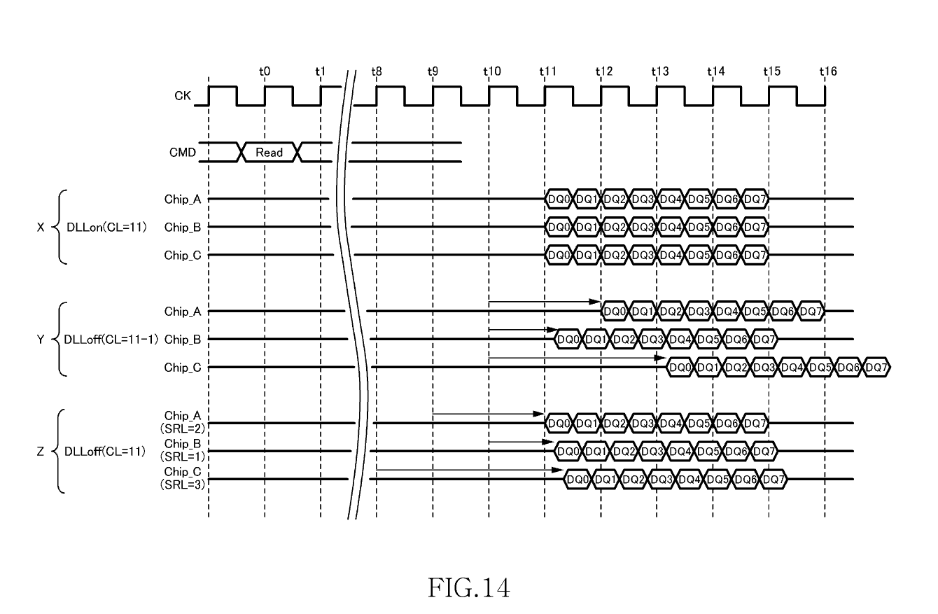

An operation of the semiconductor device 10 according to the present embodiment will be explained with reference to FIG. 14. In FIG. 14, the area X shows operations when the DLL on mode is selected. The areas Y and Z show operations when the DLL off mode is selected. Specifically, the area Y shows operations when no offset latency is used. The area Z shows operations when offset latencies are used. In any case, the value of the CAS latency (CL) is set to 11.

In the example shown in FIG. 14, a read command is issued in synchronism with the clock edge t0 of the external clock signal CK. When the DLL on mode is selected, the first pieces of read data DQ start to be output in perfect synchronism with the clock edge t11 of the external clock signal CK. As a result, even if a plurality of semiconductor devices 10 are mounted on the same module substrate, the semiconductor devices 10 output the respective pieces of read data DQ at the same timing. In FIG. 14, ChipA to ChipC represent the respective semiconductor devices 10 mounted on the same module substrate.

On the other hand, when the DLL off mode is selected, the timing at which the first pieces of read data DQ start to be output becomes asynchronous with the external clock signal CK since the phase-controlled internal clock signal LCLK is not available. In such a case, operations in synchronism with the internal clock signal ICLK are made instead of the internal clock signal LCLK. Since the internal clock signal ICLK is not advanced in phase with respect to the external clock signal CK, the output timing of the read data DQ lags behind as compared to when the DLL on mode is selected. When the DLL off mode is selected, as shown in the area Y, the set value of the CAS latency (CL) is then reduced by one to start the operation for outputting the read data DQ at the clock edge t10 of the external clock signal CK.

Even after the start of the operation for outputting the read data DQ, it takes some time to actually output the read data DQ. The time can be affected by factors such as variations in manufacturing conditions, the ambient temperature, and the operating voltage. If a plurality of semiconductor devices 10 are mounted on the same module substrate, the semiconductor devices 10 therefore actually output the read data DQ at respective different timing. In the example shown in the area Y of FIG. 14, ChipB outputs the read data DQ the earliest and ChipC outputs the read data DQ the latest.

As described above, when the DLL off mode is selected, the output timing of the read data DQ becomes asynchronous with the external clock signal CK. Note that the deactivation of the DLL circuit 23 can reduce the power consumption. In such a case, the controller connected with the semiconductor devices 10 latches the read data by using the data strobe signals DQS and /DQS.

The variations in output timing of the read data DQ when the DLL off mode is selected can be reduced by using offset latencies. For example, as shown in the area Z, the offset latency (SRL) of ChipB which outputs the read data DQ the earliest is set to 1. The offset latency (SRL) of ChipA which outputs the read data DQ next is set to 2. The offset latency (SRL) of ChipC which outputs the read data DQ the latest is set to 3. With such settings, ChipA to ChipC start the operation for outputting the read data DQ at the clock edges t9, t10, and t8 of the external clock signal CK, respectively. This reduces differences in the timing at which the read data DQ actually starts to be output. A similar operation to when the DLL on mode is selected can thus be achieved with the DLL circuit deactivated. Which value to set the offset latency (SRL) of each semiconductor device 10 to may be determined by a write leveling operation which is performed during initialization. The write leveling operation includes performing a read operation shown in the area Y of FIG. 14 and measuring the timing at which the read data DQ reaches the controller.

According to the embodiment of present invention, the first plurality of bits and the second plurality of bits are operated before decoding. The adjustment latency can thus be calculated by a logic circuit of smaller scale.

It is apparent that the present invention is not limited to the above embodiments, but may be modified and changed without departing from the scope and spirit of the invention.

For example, the foregoing embodiment has dealt with the case where the CAS latency (CL) is offset. However, the scope of application of the present invention is not limited thereto, and the present invention is applicable when the CAS write latency (CWL) is offset. The present invention is also applicable when an ODT latency is offset. The ODT latency refers to the number of clock cycles that indicates the period from the supply of the on-die termination signal ODT to the command terminal 12e to an impedance change of the data input/output terminal.

For example, the mode register according to the present invention may be a volatile circuit, a nonvolatile circuit, or a hybrid circuit thereof. While the DLL circuit is used to control the phase of an internal clock with respected to the external clock, other phase control means such as a PLL circuit may be employed. In the present invention, a circuit that controls a clock signal, like the DLL circuit and the PLL circuit, may be referred to as a “clock circuit.”

The technical ideas of the present invention can be applied to any semiconductor devices including a signal transmission circuit. Moreover, the circuit types in each circuit block disclosed in the diagrams, as well as circuits that produce control signals, are not limited to the circuit types disclosed in the example.

The technical concept of the semiconductor device of the present invention may be applied to various semiconductor devices. For example, the present invention may be applied to semiconductor products in general, including functions as CPUs (Central Processing Units), MCUs (Micro Control Units), DSPs (Digital Signal Processors), ASICs (Application Specific Integrated Circuits), ASSPs (Application Specific Standard Products), and memories. Examples of the product types of the semiconductor devices to which the present invention is applicable include an SOC (System On Chip), MCP (Multi Chip Package), and POP (Package On Package). The present invention may be applied to semiconductor devices that have any of such product types and package types.

When the transistors constituting a logic gate circuit are field effect transistors (FETs), various FETs are applicable, including MIS (Metal Insulator Semiconductor) and TFT (Thin Film Transistor) as well as MOS (Metal Oxide Semiconductor). The device may even include bipolar transistors.

In addition, an NMOS transistor (N-channel MOS transistor) is a representative example of a first conductive transistor, and a PMOS transistor (P-channel MOS transistor) is a representative example of a second conductive transistor.

Many combinations and selections of various constituent elements disclosed in this specification can be made within the scope of the appended claims of the present invention. That is, it is needles to mention that the present invention embraces the entire disclosure of this specification including the claims, as well as various changes and modifications which can be made by those skilled in the art based on the technical concept of the invention. cm What is claimed is:

1. A device comprising:
a first register temporarily storing first information indicative of a reference latency;
a second register temporarily storing second information indicative of an offset latency;
a third register temporarily storing third information indicative of one of first and second operation modes; and
a logic circuit configured to produce latency information in response to the first information when the third information is indicative of the first operation mode and to both of the first information and the second information when the third information is indicative of the second operation mode.

2. The device as claimed in claim 1, wherein the latency information takes a first value when the third information is indicative of the first operation mode and a second value when the third information is indicative of the second operation mode, the first value being different from the second value.

3. The device as claimed in claim 2, wherein the first value is greater than the second value.

4. The device as claimed in claim 1, further comprising:
a memory cell array including a plurality of memory cells;
at least one data terminal; and
an access circuit configured to accessing the memory cell array to select at least one of the memory cells, the access circuit being further configured to drive, in response to data stored in a selected memory cell, the data terminal in latency time indicated by the latency information.

5. The device as claimed in claim 4, wherein the latency time in the first operation mode is different from that in the second operation mode.

6. The device as claimed in claim 4, wherein the latency time in the first operation mode is greater than that in the second operation mode.

7. A device comprising:
a first register storing a value of a reference latency in a binary form;
a second register storing a value of an offset latency in a binary form;
a third register in which an operation mode is set;
a first logic circuit configured to subtract the value of the offset latency from the value of the reference latency to generate a first control signal indicative of a value of an adjustment latency in a binary form;
a second logic circuit configured to decode the first control signal to generate a second control signal indicative of the value of the adjustment latency in a decoded form; and
a latency counter configured to perform a count operation in synchronism with a first internal clock signal according to the second control signal when a first operation mode is set in the third register, and perform a count operation in synchronism with a second internal clock signal according to the value of the reference latency when a second operation mode is set in the third register.

8. The device as claimed in claim 7, wherein
the first internal clock signal is phase-controlled with respect to an external clock signal supplied from outside, and
the second internal clock signal is not phase-controlled with respect to the external clock signal.

9. The device as claimed in claim 8, further comprising:
a timing generation circuit configured to generate the first internal clock signal; and
a DLL circuit configured to generate the second internal clock signal,
wherein the DLL circuit is deactivated when the first operation mode is set in the third register.

10. The device as claimed in claim 9, wherein the timing generation circuit is activated regardless of whether the first or second operation mode is set in the third register.

11. The device as claimed in claim 7, wherein the value of the reference latency is supplied from outside through an address terminal, and the value of the offset latency is supplied from outside through a data input/output terminal.

12. The device as claimed in claim 11, wherein the address terminal is supplied from outside with a signal indicative of the operation mode to be set in the third register.

13. A device comprising:
a first register storing a value of a reference latency;
a second register storing a value of an offset latency;
a first logic circuit configured to logically synthesize the values of the reference latency and the offset latency to generate a first control signal; and
a second logic circuit configured to decode the first control signal to generate a second control signal.

14. The device as claimed in claim 13, wherein the first logic circuit includes a subtractor configured to subtract the value of the offset latency from the value of the reference latency.

15. The device as claimed in claim 13, wherein the value of the reference latency is supplied from outside through an address terminal, and the value of the offset latency is supplied from outside through a data input/output terminal.

16. The device as claimed in claim 13, wherein the second control signal indicates an adjustment latency, and the device outputting read data according to a value of the adjustment latency with reference to timing at which a read command is issued.

17. The device as claimed in claim 13, wherein the second control signal indicates an adjustment latency, and the device inputting write data according to a value of the adjustment latency with reference to timing at which a write command is issued.

18. The device as claimed in claim 13, wherein the second control signal indicates an adjustment latency, and the device changing an impedance of a data input/output terminal according to a value of the adjustment latency with reference to timing at which an On-Die Termination signal is issued.

19. The device as claimed in claim 13, further comprising:
a third register in which an operation mode is set; and
a data input/output circuit configured to control a data input/output terminal according to a value of an adjustment latency indicated by the second control signal with reference to at least one of a read command, a write command, and an On-Die Termination signal when a first operation mode is set in the third register, and control the data input/output terminal according to the value of the reference latency with reference to at least one of the read command, the write command, and the On-Die Termination signal when a second operation mode is set in the third register.

20. The device as claimed in claim 19, further comprising:
a first clock circuit configured to generate a first internal clock signal that is not phase-controlled based on an external clock signal supplied from outside;
a second clock circuit configured to generate a second internal clock signal that is phase-controlled based on the external clock signal; and
a latency counter configured to count the adjustment latency based on the first internal clock signal when the first operation mode is set in the third register, and count the reference latency based on the second internal clock signal when the second operation mode is set in the third register.
